(19) United States
(12) Patent Application Publication
(10) Pub. No.: US 2023/0182546 A1
(43) Pub. Date: Jun. 15, 2023

(54) Vehicle Dog Safety System and Method of Use Thereof

(71) Applicant: Taylor Yeates, Bradley, IL (US)

(72) Inventor: Taylor Yeates, Bradley, IL (US)

(21) Appl. No.: 18/062,140

(22) Filed: Dec. 6, 2022

Related U.S. Application Data
(60) Provisional application No. 63/289,250, filed on Dec. 14, 2021.

(51) Int. Cl. B60J 1/20; B60N 3/00; A01K 27/00

(52) U.S. Cl. CPC B60J 1/2094; B60N 3/00; A01K 27/002

(57) ABSTRACT

The present invention relates to a vehicle dog safety system comprising of a paw mat, seat buckle harness, and window shade with peek-a-boo hole or opening. The paw mat covers portion of car door and prevents vehicle's exterior surface from being scratched by claws of a dog leaning out of peek-a-boo hole or opening. The window shade covers window of car door and prevents air/wind from entering vehicle while providing a safe opening for the dog to lean out. The harness has a chest strap portion worn by a dog and seat belt buckle fastened to a female seat belt port of the vehicle thereby preventing aggressive movement of the dog inside the vehicle and prohibiting the dog from jumping out of the window and onto other passenger seats. The system offers a way to keep owner's vehicles protected and prevent dogs from jumping out of the window.

### CROSS-REFERENCE TO RELATED APPLICATION

The present application claims priority to, and the benefit of, U.S. Provisional Application No. 63/289,250, which was filed on Dec. 14, 2021 and is incorporated herein by reference in its entirety.

### FIELD OF THE INVENTION

The present invention relates generally to the field of dog safety. More specifically, the present invention relates to a dog safety system that includes a unique car window shade that has a hole or opening for a front portion of a dog to extend therethrough, a paw mat to cover a portion of a vehicle surface to prevent scratching from claws of the dog; and, a seat belt buckle harness configured to be worn by the dog around the chest and can be secured to a seat belt port of the car. The system enables dogs to safely hang out windows without scratching the vehicle's surface and prohibits air and wind from entering the vehicle. Accordingly, the present makes specific reference thereto. Nonetheless, it is to be appreciated that aspects of the present invention are also equally applicable to other like applications, devices, and methods of manufacture.

### BACKGROUND

By way of background, dog owners regularly travel with their dogs in their cars. Dogs when traveling in cars often times ride with their heads out of the window. Dogs have an incredible sense of smell with about 300 million olfactory receptors and therefore, during a drive, dogs like to stick their head out the window to enjoy new and interesting smells. Further, hanging the head out of the window prohibits the dogs from becoming motion sick in a moving car. However, hanging the head out of the window is dangerous and comes with the risks of dogs jumping out of moving car, accidentally falling out of the car, or getting hit by another car or object. Further, windows of a car are required to be open to accommodate dogs to lean out which enables cold/hot air, dust, and other weather elements to enter inside of the car.

While the dogs lean their head and front legs out of the window, the dog's paws are adjacent to the exterior of the vehicle out and scratch the vehicle's surface with their claws resulting in damage to the paint job. This results in expensive repair jobs and deteriorating vehicle quality.

Generally, dogs are tethered, strapped, and restrained but conventional fasteners do not properly strap dogs and the dogs may slide around in passenger seats or jump out of the window. Further, sudden turns may cause an injury to a dog. This may also result in distraction to a driver which puts the vehicle and everyone in the vehicle in danger.

Therefore, there exists a long felt need in the art for an innovative system that prevents dogs from jumping out of a window of a car. There is also a long felt need in the art for a dog safety system that can be easily used in a moving vehicle and protects dogs from injuries therein. Additionally, there is a long felt need in the art for a system that enables dogs to safely lean out of a window of a car. Moreover, there is a long felt need in the art for a safety system that prevents scratching of a vehicle's exterior surface by claws of an animal hanging out from the window of a car. Further, there is a long felt need in the art for a system that that prohibits keeps cold/hot air and wind from entering the vehicle while enabling an animal to peer out of the window. Furthermore, there is a long felt need in the art for an improved harness that prevents sliding of the dog in passenger seats. Finally, there is a long felt need in the art for a safety system that offers a way to keep owner's vehicles protected and prevents dogs from jumping out of the moving vehicle.

The subject matter disclosed and claimed herein, in one embodiment thereof, comprises a vehicle dog safety system. The system offers a way to keep vehicles protected and prevents dogs from jumping out of a car door window. The dog safety system further comprising of a generally rectangular paw mat, a seat buckle harness, and a car door window shade; the paw mat configured to cover a portion of exterior surface of a car door and is positioned below the window; the seat buckle harness includes a chest strap portion configured to be worn by a dog and an extendable belt having a seat belt buckle; the car door window shade is configured to cover the window and includes an opening sized to allow a dog to lean its upper body out of the window; the paw mat protects the exterior surface of the vehicle from paws and nails of a dog leaning out of the opening; the seat belt buckle is fastened to seat belt button/holder of the vehicle for prohibiting the dog from jumping out of the window and the window shade prevents the cold air and dust from entering inside of the vehicle while enabling the dog to lean out from the opening.

In this manner, the safety system of the present invention accomplishes all of the forgoing objectives and provides users with a weighted, magnetized paw mat for animals that hang front legs out of car windows to prevent scratching of vehicle surface. A window fabric cover with an opening to prohibit cold/hot air and wind from entering vehicle while enabling dogs and other animals to safely hang out of the window. The system enables dogs to enjoy their ride but not cool down, or warm-up, the interior of the vehicle while safely strapping the dogs inside the car.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle dog safety system. The dog safety system further comprising of a paw mat, a seat buckle harness, and a car door window shade; the paw mat is generally rectangular and is configured to cover a portion of the exterior surface of a car door; the seat buckle harness includes a chest strap portion configured to be worn by a dog and an extendable belt having a seat belt buckle; the car door window shade is configured to cover window and includes a hole sized to allow a dog to lean out of the window; the paw mat protects the exterior surface of the vehicle from paws of a dog leaning out of the hole; the seat belt buckle is fastened to the seat belt button/holder of the vehicle for prohibiting the dog from jumping out of the window and the window shade prevents the cold air (or hot air) and dust from entering inside of the vehicle.

In yet another embodiment, the paw mat is deployed below the car door window such that the paw mat covers a portion of the exterior surface of the car door and the paw mat is folded inside of the vehicle along the bottom edge of the car door window and is releasably clipped to the bottom of the car door inside of the vehicle.

In yet another embodiment, the window shade is releasably attached along edges of the car door window using a fastener.

In yet another embodiment, the paw mat has a magnetic layer disposed between a front layer and a rear layer wherein the magnetic layer provides magnetic coupling of the paw mat with the exterior surface of the car door.

In yet another embodiment, a mat and screen assembly for a car door is disclosed. The assembly is used for preventing damage to a car door from paws of a dog and preventing the dog from jumping out of the car door window. The assembly includes a multi-layered generally rectangular paw mat having a layer of rubber and a layer of soft silicone material, the mat covers a portion of the exterior surface of the car door and is secured to the interior of the car door; the screen assembly includes a mesh cover having a peek-a-boo hole or opening, wherein the hole is dimensioned as per the dog and the dog safely leans out of the hole such that the rubber layer of the mat is in contact with the paws of the dog; a harness configured to be worn around the chest of the dog and having a seat belt clip wherein the seat belt clip is fastened to a universal seat belt button of the car for preventing the dog from jumping out of the peek-a-boo hole or opening.

In yet another embodiment, the mesh cover slides over the window for providing a shield to prohibit air and wind from entering the car.

In yet another embodiment, the paw mat does not slide or misplace (i.e. remains stationary) in a moving vehicle.

In yet another embodiment, a method of preventing a dog from jumping out of the window of a car is disclosed. The method includes the steps of sliding a window cover over the window of a car door, wherein the cover has a peek-a-boo hole or opening; fastening a harness worn by the dog to the universal seat belt port of the car; covering a portion of the exterior surface of the car door by a paw mat wherein the paw mat is secured to the interior of the car door; the dog leans out of the opening while the harness prevents the dog from jumping out; the paw mat prevents contact of the paws and nails of the dog with the exterior surface of the car door wherein the paws and nails are in contact with the paw mat and not the car door.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a vehicle dog safety system of the present invention in accordance with the disclosed architecture;

FIG. 2 illustrates a partial perspective view of a car door with the vehicle dog safety system installed thereon in accordance with the disclosed architecture;

FIG. 3 illustrates a perspective view of the seat buckle connection of the harness and attachment of the paw mat on the interior of the door in accordance with the disclosed architecture;

FIG. 4 illustrates a perspective view of a dog leaning out of the window shade and contacting the paw mat in accordance with the disclosed architecture;

FIG. 5 illustrates a perspective view of a dog wearing the harness of the vehicular door mat and shade system of the present invention in accordance with the disclosed architecture; and

FIG. 6 illustrates a cross-sectional view of the paw mat of the present invention showing different layers used in construction thereof in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for an innovative system that prevents dogs from jumping out of a window of a car. There is also a long felt need in the art for a dog safety system that can be easily used in a moving vehicle and protects dogs from injuries therein. Additionally, there is a long felt need in the art for a system that enables dogs to safely lean out of a window of a car. Moreover, there is a long felt need in the art for a safety system that prevents scratching of a vehicle's exterior surface by claws of an animal hanging out from the window of a car. Further, there is a long felt need in the art for a system that that prohibits keeps cold/hot air and wind from entering the vehicle while enabling an animal to peer out of the window. Furthermore, there is a long felt need in the art for an improved harness that prevents sliding of the dog in passenger seats. Finally, there is a long felt need in the art for a safety system that offers a way to keep owner's vehicles protected and prevents dogs from jumping out of the moving vehicle.

The present invention, in one exemplary embodiment, is a mat and screen assembly for a car door. The assembly is used for preventing damage to a car door from paws of a dog and prohibiting the dog from jumping out of the car door window. The assembly includes a multi-layered paw mat having a layer of rubber and a layer of soft silicone material, the mat covers a portion of the exterior surface of the car door and is releasably secured to car door in the interior of the car; the screen assembly includes a mesh cover having a peek-a-boo hole or opening, wherein the opening is dimensioned as per the dog and the dog safely leans out of the opening such that the rubber layer of the mat is contacted by paws of the dog; a harness configured to be worn around chest of the dog and having a seat belt clip wherein the seat belt clip is fastened to a universal seat belt button of the car for prohibiting the dog from jumping out of the peek-a-boo opening.

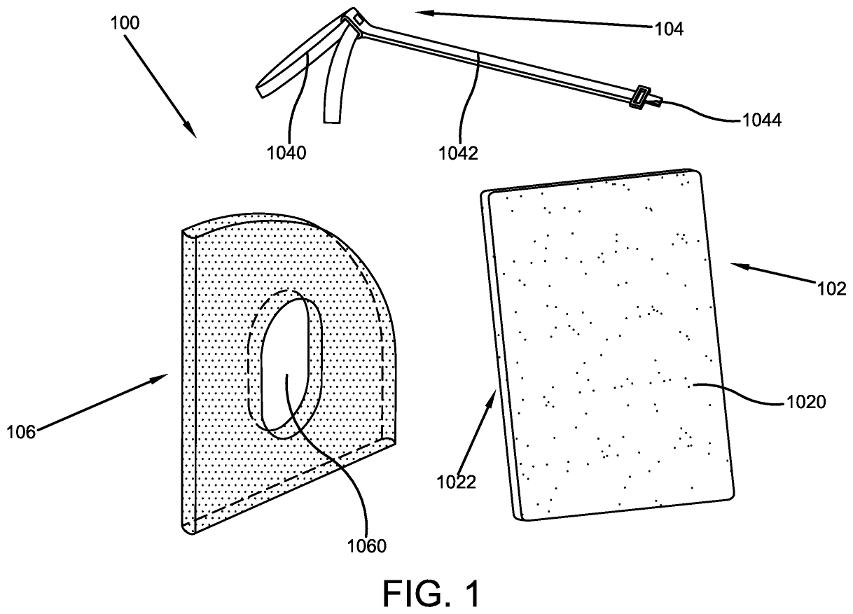

Referring initially to the drawings, FIG. 1 illustrates a perspective view of one potential embodiment of the vehicle dog safety system of the present invention in accordance with the disclosed architecture. The vehicle dog safety system 100 of the present invention is designed to allow dogs to safely hang out of windows of a vehicle without scratching up the vehicle's exterior surface. The system 100 enables dogs to safely place their head and front legs out of the window while prohibiting them from jumping out of the window and therefore, improves security for the driver and other passengers as well.

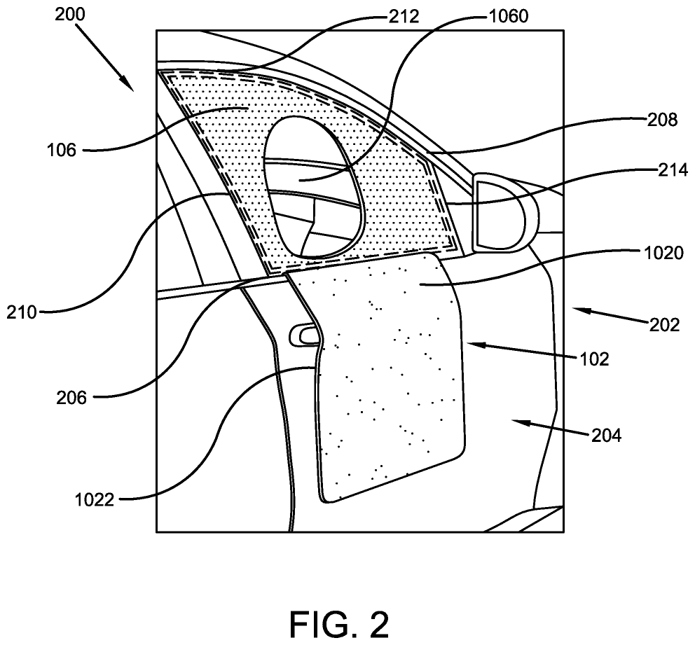

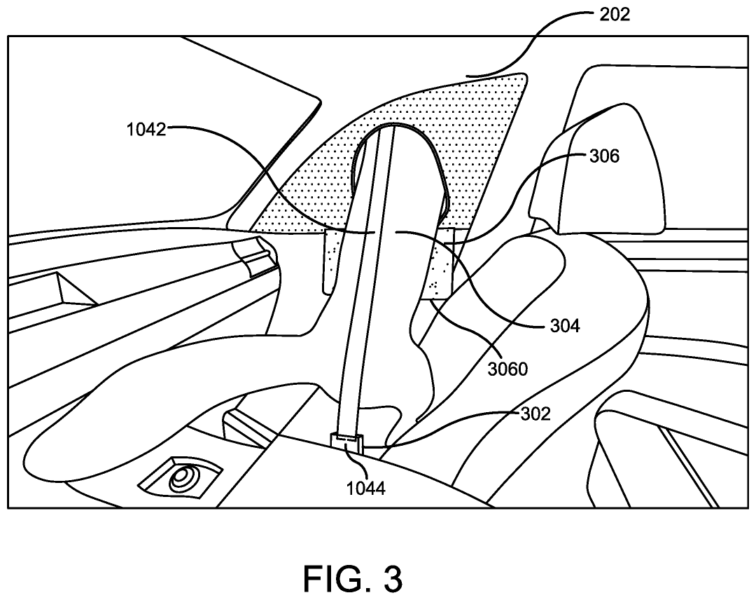

More specifically, the system 100 includes a weighted and magnetized paw mat 102. The paw mat 102 is designed to prevent scratching of a vehicle's exterior surface by paws of a dog. The paw mat 102 is a generally rectangular mat having a front layer 1020 and a rear layer 1022. The front layer 1020 is configured to be facing away from a vehicle's surface and the rear layer 1022 contacts the vehicle's exterior surface 204 as shown in FIG. 2. The front layer 1020 is made from rubber material and does not wear easily and prevents the nails of a dog from reaching the vehicle's exterior surface 204. The rear layer 1022 is made from soft material, such as, silicone and does not scratch the vehicle's exterior surface and further, prevents sliding of the mat 102 in a moving vehicle. The mat 102 can come in different sizes and shapes to fit designs and sizes of the window of a vehicle. The mat 102 is removably attached near the bottom of the door on the interior of the vehicle as illustrated in FIG. 3.

A safety harness 104 is designed as a chest strap portion or as a collar 1040 with an attached seat belt buckle 1044 equipped belt 1042. The chest strap portion 1040 is configured to be worn by a dog such that the belt 1042 is stretched or flexed and the seat belt buckle 1044 is secured to the standard seat belt buckle button (i.e. female connector) for securing the dog. The belt 1042 is adjustable and can be made of nylon. Further the chest strap portion 1040 and the belt 1042 are permanently attached and may be sewn together.

A car window shade 106 having a peek-a-boo hole or opening 060 is configured to cover the window of a vehicle for preventing a dog from escaping or jumping out of the window. The window shade 106 is made of a stretchable mesh which is flexible and is removably attached to the window while dogs can safely poke their heads out of the hole or opening 1060 in order to lean out the window safely while the car is moving. The shade 106 is also configured to provide a shield against the cold/hot air and wind. The shade 106 is great for use in colder climates or seasons, when the dogs enjoy their ride while the interior of the vehicle retains a comfortable temperature.

It should be appreciated that the system 100 consisting of the paw mat 102, the seat buckle harness 104, and the mesh window shade 106 ensures that the dog within a vehicle remains safe while enjoying the outside from the window access. Further, the exterior of the vehicle is also protected from scratches caused by nails of a dog. The driver and other passengers can be safe as the dog is secured using the harness belt 1042 fastened to the standard seat belt buckle button of the vehicle.

The system 100 can be designed and sized to fit sizes of different vehicles and different breeds of dogs. The system 100 is removably attached to a vehicle and can come in different colors and designs to match the aesthetics of a vehicle. The size of the peek-a-boo hole 1060 can also be sized to fit a dog's size and breed.

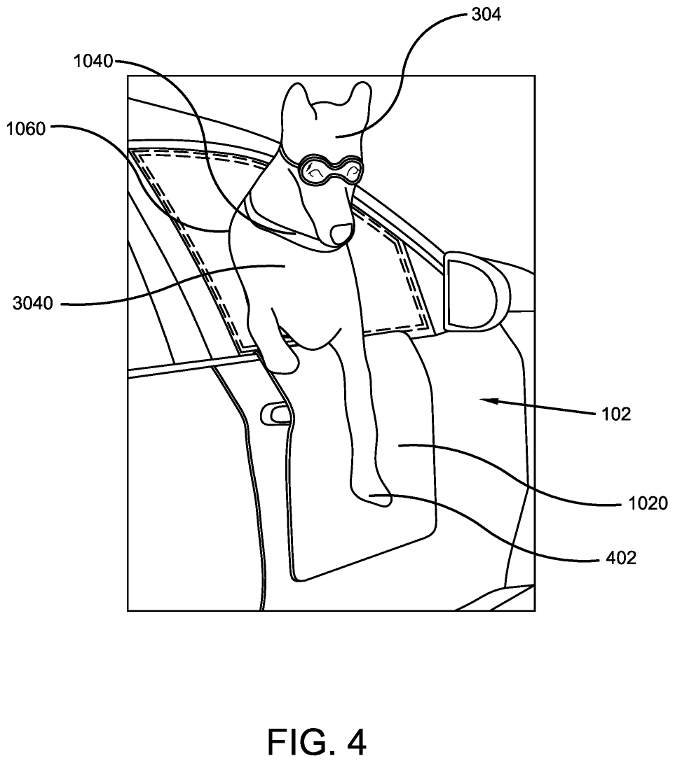

FIG. 2 illustrates a partial perspective view of a car door with the vehicle dog safety system installed thereon in accordance with the disclosed architecture. The paw mat 102 is placed on the exterior surface 204 of the car door 202 such that the mat 102 covers a portion of the exterior surface 204 of the car door 202. The paw mat 102 is clipped to the bottom of the door 202 inside of the vehicle 200 and is folded on the bottom edge 206 of the door window 208. The front layer 1020 of the paw mat 102 faces away from the exterior surface 204 and is contacted by paws of a dog as shown in FIG. 4. The rear surface 1022 adheres to the exterior surface 204 and prevents sliding or movement of the mat 102 due to air while the vehicle 200 is moving. The mat 102 can have a magnetic layer disposed between the front layer 1020 and the rear layer 1022 enabling the mat 102 to make a strong attachment with the exterior surface 204 of the car door 202.

The window mesh cover 106 is dimensioned and shaped as per the door window 208 and is removably attached to the car door 202 along the edges of the window 208. In the preferred embodiment, the cover 106 is removably attached to the edges 206, 210, 212, 214 of the window 208 using an adhesive. Alternatively, the cover 106 can be folded along the edges 206, 210, 212, 214 to securely place the cover 106 and to surround the window opening 208.

The peek-a-boo opening 1060 is dimensioned and positioned such that the hole 1060 is preferably positioned around the center of the window opening 208 and therefore, enables a dog to easily hang out from the window without fear of jumping out of the window 208. It should be appreciated that the mesh shade 106 protects inside of the vehicle 200 from air, dirt, and more from entering therein.

FIG. 3 illustrates a perspective view of the seat buckle connection of the harness and attachment of the paw mat on the interior of the door in accordance with the disclosed architecture. As illustrated, the belt 1042 of the harness 104 has a universal seat belt buckle or male connector 1044 and is received by the female seat belt buckle button 302 of the vehicle 200. The universal seat belt buckle 1044 is designed to fit to the female seat belt buckle button of any vehicle and therefore, enables a user to use the harness in any vehicle. The length of the belt 1042 is adjusted such that the dog 304 easily and partially can move out of the hole or opening 1060. Since the dog 304 is secured using the harness 104, therefore, a driver or other passengers of the vehicle 200 can easily drive and sit inside the vehicle without fear of the dog 304 jumping on them or out of a window.

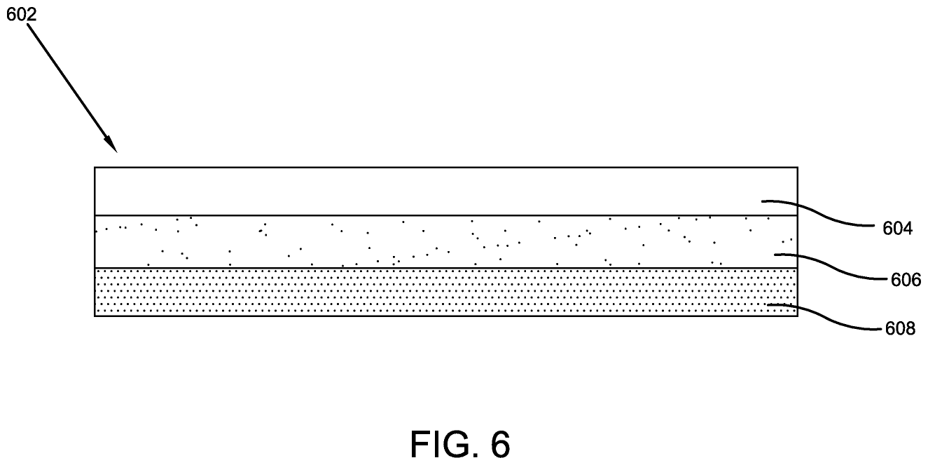

As described earlier, the paw mat 102 is clipped to the bottom of the car door 202 inside of the vehicle. A portion 306 of the paw mat 102 is folded inside of the vehicle 200 and can be clipped or attached using conventional fasteners such as clips, hook and loop fastener, snap button, or more along the bottom edge 3060 of the portion 306. The attachment of the paw mat 102 to inside of the vehicle prevents sliding and movement of the paw mat 102. Further, as described earlier and as shown in FIG. 6, the magnetic layer of the paw mat 102 also helps to secure placement on the exterior surface of the car door.

FIG. 4 illustrates a perspective view of a dog leaning out of the window shade and contacting the paw mat in accordance with the disclosed architecture. The dog and vehicle safety system 100 of the present invention enables the dog 304 to safely lean out of the opening 1060 such that the dog 304 enjoys the outdoor air and can move the paws 402 to contact the front layer 1020 of the paw mat 102. The front layer 1020 does not easily wear and prevents the contact of nails of the dog 304 with the exterior surface 204 of the car door 202.

The window shade 106 prevents air, dirt, and other weather elements from reaching inside of the vehicle 200 while providing adequate space for the dog 304 to safely lean out. The collar/chest strap portion 1040 is wrapped around chest 3040 of the dog 304 and is tied to the seat belt button as described in FIG. 3. The chest strap portion 1040 can be made from leather, nylon webbing, polyester, hemp, metal, or oilcloth and can be made in different designs and textures.

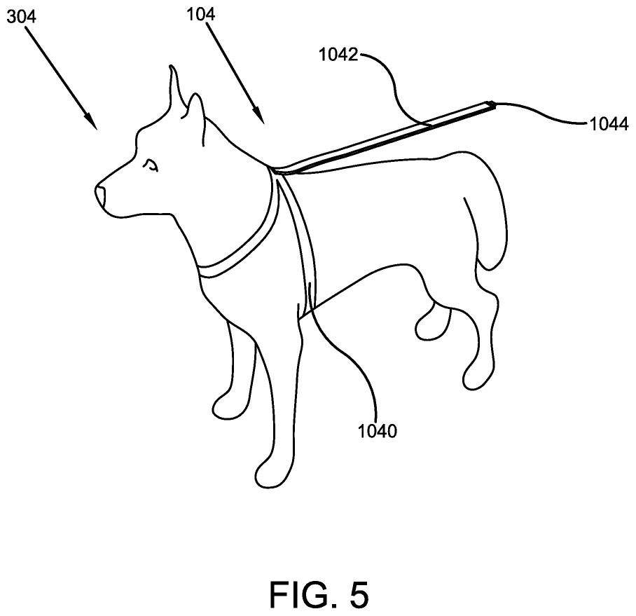

FIG. 5 illustrates a perspective view of a dog wearing the harness 104 of the vehicular door mat and shade system 100 of the present invention in accordance with the disclosed architecture. The chest strap portion 1040 is configured to be worn around chest 3040 such that the sewn end 502 of the belt 1042 is positioned on top of the chest 3040 of the dog 304. The belt 1042 is adjustable and can have a length of up to four feet. The universal seat belt buckle 1044 is made of stainless steel and can be easily pushed into the female seat belt button of a vehicle for a secure connection and fastening the harness 104.

FIG. 6 illustrates a cross-sectional view of the paw mat of the present invention showing different layers used in the construction thereof in accordance with the disclosed architecture. As illustrated, in the present embodiment, the paw mat 602 includes the front layer 604 formed of durable rubber and can have a thickness of from about 0.5″ to about 1.5″. A middle layer 606 is magnetized and formed of a magnetic material enabling the paw mat 602 to magnetically couple to the exterior surface 204 of the vehicle. The magnetic material helps in stable positioning of the paw mat even when a dog vigorously scratches the paw mat in a moving vehicle.

The rear layer 608 is formed of soft and durable material like silicone that does not obstruct the magnetic properties of the middle layer 606 and prevents any damage to the exterior surface of a car door. Also, the rear layer 608 is slip resistant and attaches onto the car door. It should be appreciated that the front layer 604 and the rear layer 608 can be designed in different designs and shapes and all the three layers can be sewn together along the edges for forming a one-piece construction.

It should be appreciated that the safety system 100 can be easily carried in a vehicle and can be used for a dog easily. The paw mat is safe to deploy on a car door while the harness protects the dog and prevents same from jumping from the window. The window shade prevents the cold/hot air and dust from entering inside of the vehicle and therefore, the system 100 is not only useful and safe for a dog but also safe for driver and other passengers.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “dog and vehicle safety system”, “vehicular door mat and shade system”, “vehicle dog safety system”, and “safety system” are interchangeable and refer to the vehicle dog safety system 100 of the present invention.

Notwithstanding the forgoing, the vehicle dog safety system 100 of the present invention can be of any suitable size and configuration as is known in the art without affecting the overall concept of the invention, provided that it accomplishes the above stated objectives. One of ordinary skill in the art will appreciate that the vehicle dog safety system 100 as shown in the FIGS. are for illustrative purposes only, and that many other sizes and shapes of the vehicle dog safety system 100 are well within the scope of the present disclosure. Although the dimensions of the vehicle dog safety system 100 are important design parameters for user convenience, the vehicle dog safety system 100 can be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle dog safety system for enabling a portion of a dog to extend out of a vehicle window, the vehicle dog safety system comprising:
a weighted and magnetized paw exterior mat portion having a front layer and a rear layer;
wherein said front layer facing away from a vehicle's exterior surface;
wherein said rear layer contacting the vehicle's exterior surface;
a safety harness for securing to a dog at one end and to a female seat belt connector at another end; and
an interior mat portion having a fastener for removably attaching to a vehicle's interior surface.

2. The dog safety system of claim 1, wherein said exterior mat portion is generally rectangular.

3. The dog safety system of claim 2, wherein said interior mat portion is generally rectangular.

4. The dog safety system of claim 1, wherein said front layer includes a rubber material.

5. The dog safety system of claim 4, wherein said rear layer includes a silicone material.

6. The dog safety system of claim 5, wherein said safety harness having a male connector for fastening to a vehicle female seatbelt buckle.

7. The dog safety system of claim 6, wherein said safety harness having a chest strap portion for securing around a dog's chest.

8. The dog safety system of claim 7, wherein said safety harness having a collar portion for securing around a dog's neck.

9. The dog safety system of claim 8, wherein said safety harness includes an adjustable length.

10. The dog safety system of claim 1, further comprising a car window shade having an opening therethrough configured to removably attach to a perimeter of a vehicle window.

11. The dog safety system of claim 10, wherein said window shade having a stretchable mesh material.

12. The dog safety system of claim 1, further comprising a magnetized layer disposed between said front layer and said rear layer adhering to the vehicle's exterior surface.

13. The dog safety system of claim 9, wherein said safety harness includes a material selected from a group consisting of a leather, a nylon webbing, a polyester, a hemp, a metal, and an oilcloth.

14. A vehicle dog safety system for enabling a portion of a dog to extend out of a vehicle window, the vehicle dog safety system comprising:
a weighted and magnetized paw exterior mat portion having a front layer, a rear layer, and a middle layer therebetween;
wherein said front layer facing away from a vehicle's exterior surface;
wherein said rear layer contacting the vehicle's exterior surface;
wherein said middle layer is magnetized for adhering to the vehicle's exterior surface; and
a safety harness for securing to a dog at one end and to a female seat belt connector at another end.

15. The dog safety system of claim 14 further comprising an interior mat portion having a fastener for removably attaching to a vehicle's interior surface.

16. The dog safety system of claim 15, wherein said front layer includes a rubber material.

17. The dog safety system of claim 16, wherein said rear layer includes a silicone material.

18. The dog safety system of claim 17, wherein said safety harness having a male connector for fastening to a vehicle female seatbelt buckle.

19. A vehicle dog safety system for enabling a portion of a dog to extend out of a vehicle window, the vehicle dog safety system comprising:
a weighted and magnetized paw exterior mat portion having a front layer, a rear layer, and a middle layer therebetween;
wherein said front layer facing away from a vehicle's exterior surface;
wherein said rear layer contacting the vehicle's exterior surface;
wherein said middle layer is magnetized for adhering to the vehicle's exterior surface;
an adjustable length safety harness for securing to a dog at one end and to a female seat belt connector at another end; and
a car window shade having an opening therethrough configured to removably attach to a perimeter of a vehicle window.

20. The dog safety system of claim 19 further comprising an interior mat portion having a fastener for removably attaching to a vehicle's interior surface.
